(19) United States
(12) Patent Application Publication
(10) Pub. No.: US 2025/0011181 A1
(43) Pub. Date: Jan. 9, 2025

(54) METHOD FOR PREPARING LITHIUM HYDROXIDE BY USING LITHIUM CARBONATE AND BARIUM COMPOUND

(71) Applicant: INDUSTRY FOUNDATION OF CHONNAM NATIONAL UNIVERSITY, Gwangju (KR)

(72) Inventor: MYONG JUN KIM, Gwangju (KR)

(21) Appl. No.: 18/706,845

(22) PCT Filed: Oct. 28, 2022
(86) PCT No.: PCT/KR2022/016688

§ 371 Date: May 2, 2024

(30) Foreign Application Priority Data
Nov. 5, 2021 (KR) 10-2021-0151348

(51) Int. Cl. C01D 15/02

(52) U.S. Cl. CPC C01D 15/02; C01P 2002/72; C01P 2006/80

(57) ABSTRACT

In a method of preparing lithium hydroxide, a mixture of low-purity lithium carbonate and barium hydroxide is heat-treated, the resulting product obtained through the heat treatment is leached by adding water to form a first slurry including an aqueous lithium hydroxide solution and an insoluble by-product, the first slurry is filtered to separate the lithium hydroxide solution and the insoluble by-product, and the lithium hydroxide solution separated through the filtering of the first slurry is evaporated, thereby obtaining lithium hydroxide.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2022/016688 filed on Oct. 28, 2022, which claims priority to the benefit of Korean Patent Application No. 10-2021-0151348 filed in the Korean Intellectual Property Office on Nov. 5, 2021, the entire contents of which are incorporated herein by reference.

### BACKGROUND

### 1. Technical Field

The present disclosure relates to a method of preparing lithium hydroxide and, more particularly, to a method of preparing lithium hydroxide by using lithium carbonate and a barium compound, the method being economical due to the simple process compared to that in the related art, improving energy efficiency, and enabling lithium hydroxide to be environmentally friendly prepared without waste generation.

### 2. Background Art

Typically, in secondary batteries for electric vehicles, there is a trend to mainly use positive electrode materials with a nickel content of 80 mol % or more, such as nickel-cobalt-aluminum (NCA) and high nickel-based NCM 811, considering characteristics such as stability, capacity, and output.

Unlike existing positive electrode materials, positive electrode materials such as NCA and NCM 811 are prepared using lithium hydroxide instead of lithium carbonate as the lithium source. This is because when the nickel content is 80 mol % or more in a preparation process of positive electrode materials, electric storage capacity characteristics can be realized without difficulty only with the use of lithium hydroxide, which has relatively excellent reactivity and can be calcined at low temperatures.

Lithium is conventionally extracted from salt lakes and ores. Lithium extraction from salt lakes involves a process of converting a water-soluble lithium chloride to lithium carbonate with low water solubility (water solubility: 1.29 g/100 ml, 20° C.), which precipitates as a precipitate, and then converting the resulting precipitate to lithium hydroxide.

In lithium extraction from ores, ores are roasted with sulfuric acid and eluted in water to prepare a lithium sulfate solution, and then lithium hydroxide is prepared from lithium carbonate with low water solubility in the same manner as the process in lithium extraction from salt lakes. Existing methods of preparing lithium hydroxide had the problem in that the recovery of lithium with solubility below that of lithium carbonate, an intermediate product, was challenging (see FIG. 1).

In this case, the process of converting lithium carbonate to lithium hydroxide involves dissolving lithium carbonate in water, reacting the resulting product with calcium hydroxide to remove calcium carbonate generated as a precipitate, and then concentrating the remaining lithium hydroxide in the solution to obtain high-purity lithium hydroxide. Such a process can be represented by Chemical Equation 1 below:

Li₂CO₃(s)+Ba(OH)₂(s)→2LiOH(s)+BaCO₃(s) [Chemical Equation 1]

However, although the reaction shown in Reaction Formula 1 proceeds as an aqueous reaction, the water solubilities of lithium carbonate and calcium hydroxide, the reactants, are extremely low at 1.29 g/100 ml (at a temperature of 25° C.) and 0.173 g/100 mL (at a temperature of 20° C.), respectively. Accordingly, the amount of the reactants enabled to react at once is limited, and a relatively large amount of water is used, making the amount of water required to be evaporated to separate lithium hydroxide later increase and thus resulting in increased energy consumption.

Additionally, calcium carbonate can be dissolved in water to some extent, so the lithium hydroxide solution contains some calcium carbonate. In this case, the calcium ions derived from this solution may significantly deteriorate the performance of lithium-ion batteries. As a result, there is a problem in that lithium hydroxide obtained by removing water must be recrystallized 2 to 3 times to obtain battery-grade high-purity lithium hydroxide.

Although there is a great deal of research being in progress to solve these problems, an optimal solution has not yet been developed.

### SUMMARY

The inventors of the present disclosure developed a technology for preparing lithium hydroxide using low-purity lithium carbonate and a barium compound, thereby completing the present disclosure.

Therefore, the present disclosure aims to provide a method of preparing lithium hydroxide using lithium carbonate and a barium compound, the method capable of preparing high-purity lithium hydroxide while minimizing the loss rate of lithium by using low-purity lithium carbonate and one or more among barium hydroxide and barium oxide.

Additionally, the present disclosure aims to provide a method of preparing lithium hydroxide using lithium carbonate and a barium compound, the method being economical due to the simple process compared to that in the related art, improving energy efficiency, and being environmentally friendly without waste generation.

The objectives of the present disclosure are not limited to the objectives mentioned above and, unless otherwise expressly mentioned, may include other objectives of the present disclosure that can be recognized by those skilled in the art from the following detailed descriptions.

To solve the objectives of the present disclosure mentioned above, the present disclosure provides a method of preparing lithium hydroxide, the method including: performing heat treatment on a mixture of low-purity lithium carbonate and barium hydroxide; leaching the resulting product obtained through the heat treatment by adding water to form a first slurry including an aqueous lithium hydroxide solution and an insoluble by-product; filtering the first slurry to separate the lithium hydroxide solution and the insoluble by-product; and evaporating the lithium hydroxide solution separated through the filtering of the first slurry, thereby obtaining lithium hydroxide.

Additionally, the present disclosure provides a method of preparing lithium hydroxide, the method including: performing heat treatment on a mixture of low-purity lithium carbonate and barium oxide; leaching the resulting product obtained through the heat treatment by adding water to form a first slurry including an insoluble by-product and a soluble component solution in which a soluble component is dissolved; converting lithium carbonate included in the soluble component to lithium hydroxide by adding a barium hydroxide solution to the first slurry, thereby forming a second slurry; filtering the second slurry to separate a lithium hydroxide solution and the insoluble by-product; and evaporating the lithium hydroxide solution separated through the filtering of the second slurry, thereby obtaining lithium hydroxide.

Additionally, the present disclosure provides a method of preparing lithium hydroxide, the method including: performing heat treatment on a mixture of low-purity lithium carbonate, barium hydroxide, and barium oxide; leaching the resulting product obtained through the heat treatment by adding water to form a first slurry including an insoluble by-product and a soluble component solution in which a soluble component is dissolved; converting lithium carbonate included in the soluble component to lithium hydroxide by adding a barium hydroxide solution to the first slurry, thereby forming a second slurry; filtering the second slurry to separate a lithium hydroxide solution and the insoluble by-product; and evaporating the lithium hydroxide solution separated through the filtering of the second slurry, thereby obtaining lithium hydroxide.

In preferred embodiments, in the performing of the heat treatment, one or more reactions represented by Chemical Equations 1 and 2 below occur.

Li₂CO₃(s)+Ba(OH)₂(s)→2LiOH(s)+BaCO₃(s) [Chemical Equation 1]

Li₂CO₃(s)+BaO(s)→Li₂O(s)+BaCO₃(s) [Chemical Equation 2]

In preferred embodiments, in the leaching of the resulting product, reactions represented by Chemical Equations 3 and 4 below occur.

Li₂O(s)+H₂O→2LiOH(aq) [Chemical Equation 3]

Li₂CO₃(s)→Li₂CO₃(aq) [Chemical Equation 4]

In preferred embodiments, in the converting of lithium carbonate, a reaction represented by Chemical Equation 5 below occurs.

Li₂CO₃(aq.)+Ba(OH)₂(aq.)→2LiOH(aq.)+BaCO₃(s) [Chemical Equation 5]

In preferred embodiments, in the evaporating of the lithium hydroxide solution, a reaction represented by Chemical Equation 6 below occurs.

LiOH+xH₂O→LiOH·H₂O [Chemical Equation 6]

In preferred embodiments, the method further includes performing reduction heat treatment on a mixture of a carbon raw material and the insoluble by-product obtained through the filtering of the first or second slurry in a reducing atmosphere.

In preferred embodiments, in the performing of the reduction heat treatment, a reaction represented by Chemical Equation 7 below occurs.

BaCO₃(s) (99.5%)+C(s)→BaO(s)+2CO(g): 2CO+O₂→2CO₂ [Chemical Equation 7]

In preferred embodiments, BaO(s) obtained from the reaction represented by Chemical Equation 7 is reused as barium oxide required in the performing of the heat treatment.

In preferred embodiments, the method further includes: leaching the resulting product obtained through the reduction heat treatment by adding water to form a third slurry including an aqueous barium hydroxide solution and impurities; filtering the third slurry to separate the barium hydroxide solution and the impurities; and evaporating the barium hydroxide solution separated through the filtering of the third slurry to obtain barium hydroxide.

In preferred embodiments, in the leaching of the resulting product, a reaction represented by Chemical Equation 8 below occurs, and in the evaporating of the barium hydroxide solution, a reaction represented by Chemical Equation 9 below occurs.

BaO(s)+H₂O (l)→Ba(OH)₂(aq.) [Chemical Equation 8]

Ba(OH)₂(aq.)+xH₂O→Ba(OH)₂(s) [Chemical Equation 9]

In preferred embodiments, BaO(s) obtained from the reaction represented by Chemical Equation 9 is reused as barium hydroxide required in the performing of the heat treatment.

In preferred embodiments, the reduction heat treatment is performed at a temperature in a range of 850° C. to 1,100° C. in an inert atmosphere.

In preferred embodiments, the carbon raw material includes any one or more selected from the group consisting of graphite, activated carbon, carbon black, amorphous carbon, and a combination thereof.

In preferred embodiments, barium carbonate included in the insoluble by-product and the carbon raw material are mixed such that a molar ratio thereof is in a range of 1:0.95 to 1:2.

In preferred embodiments, in the performing of the heat treatment, a molar ratio of lithium carbonate to barium hydroxide or barium oxide included is in a range of 1:0.5 to 1:1.5.

In preferred embodiments, in the performing of the heat treatment, lithium carbonate, barium hydroxide, and barium oxide are included such that the total amount of barium hydroxide and barium oxide is in a range of 0.5 to 1.5 moles per 1 mole of lithium carbonate.

According to the method of preparing lithium hydroxide of the present disclosure described above, lithium hydroxide can be prepared with high purity while minimizing the loss rate of lithium by using low-purity lithium carbonate and one or more among barium hydroxide and barium oxide.

Additionally, according to the present disclosure, the method of preparing lithium hydroxide is economical due to the simple process compared to that in the related art, improves energy efficiency, and is environmentally friendly without waste generation.

The technical effects of the present disclosure are not limited to the scope mentioned above and, unless otherwise expressly mentioned, may include other effects of the present disclosure that can be recognized by those skilled in the art from the following detailed descriptions for implementing the present disclosure.

### BRIEF DESCRIPTION OF THE DRAWINGS

FIG. 1 is a schematic diagram showing an existing method of preparing lithium hydroxide;

FIGS. 2A to 2C are schematic diagrams showing the process flows according to Examples 1 to 3 of methods of preparing lithium hydroxide of the present disclosure, respectively;

FIGS. 3A and 3B show thermodynamic simulation results for heat treatment conditions in Examples 1 and 2 according to methods of preparing lithium hydroxide of the present disclosure;

FIGS. 4A and 4B show a graph for XRD analysis results and an actual image of the resulting product obtained through a heat treatment step performed in Example 1;

FIGS. 5A and 5B are graphs showing XRD analysis results of an insoluble by-product obtained through filtering steps performed in Examples 1 and 2, respectively;

FIGS. 6A and 6B show a graph for XRD analysis results and an actual image of lithium hydroxide crystals, respectively, in which the crystals are obtained through evaporating steps performed in Examples 1 to 3 to obtain lithium hydroxide;

FIG. 7 shows thermodynamic simulation results for reduction heat treatment conditions in Examples 1 to 3 of methods of preparing lithium hydroxide of the present disclosure;

FIG. 8 is a graph showing XRD analysis results of the resulting product obtained through reduction heat treatment in Example 2; and

FIG. 9 is a graph showing XRD analysis results of barium hydroxide crystals obtained through evaporating steps performed in Examples 1 and 3 to obtain barium hydroxide.

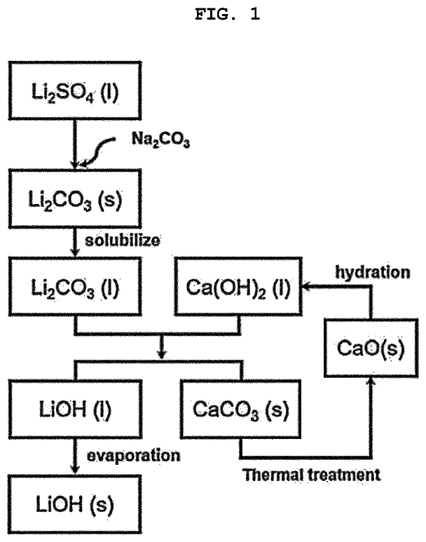

### DETAILED DESCRIPTION

The terms used herein are only used to describe specific embodiments and are not intended to limit the disclosure. As used herein, unless the context clearly indicates otherwise, the singular forms are intended to include the plural forms as well. It will be further understood that the terms “comprises”, “includes”, or “has” used herein specify the presence of stated features, regions, integers, steps, operations, elements, and/or components, but do not preclude the presence or addition of one or more other features, regions, integers, steps, operations, elements, components, and/or combinations thereof.

Terms used herein, such as first, second, and the like, may be used to describe various components, but the components are not to be construed as being limited to the terms. These terms are used only for the purpose of distinguishing a component from another component. For example, without departing from the scope of the present disclosure, a first component may be referred to as a second component, and a second component may be also referred to as a first component.

Unless otherwise defined, all terms used herein, including technical or scientific terms, have the same meaning as commonly understood by those skilled in the art to which the present disclosure pertains. It will be further understood that terms, such as those defined in commonly used dictionaries, should be interpreted as having a meaning that is consistent with their meaning in the context of the related art and the present disclosure, and will not be interpreted in an idealized or overly formal sense unless expressly so defined herein.

In interpreting the components, even if there is no separate explicit description, it is interpreted as including the error range. In particular, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

When the temporal relationship between two events is described using the terms “after”, “following”, “next”, “before”, and the like, the two events may not occur in succession as long as the term “immediately” or “directly” is not used.

Hereinafter, the technical configuration of the present disclosure will be described in detail with reference to the attached drawings and preferred embodiments.

However, the present disclosure is not limited to the embodiments described herein and may be embodied in other forms. Like reference numerals are used to identify like elements throughout different drawings.

The present disclosure is technically characterized by a method of preparing lithium hydroxide using lithium carbonate and a barium compound, the method enabling lithium hydroxide to be prepared with high purity while minimizing the loss rate by using low-purity lithium carbonate and one or more among barium hydroxide and barium oxide, being economical due to the simple process compared to that in the related art, improving energy efficiency, and being environmentally friendly without waste generation.

Accordingly, the present disclosure provides the following three methods of preparing lithium hydroxide. A first method includes the following steps: performing heat treatment on a mixture of low-purity lithium carbonate and barium hydroxide; leaching the resulting product obtained through the heat treatment by adding water to form a first slurry including an aqueous lithium hydroxide solution and an insoluble by-product; filtering the first slurry to separate the lithium hydroxide solution and the insoluble by-product; and evaporating the lithium hydroxide solution separated through the filtering of the first slurry, thereby obtaining lithium hydroxide.

Additionally, a second method includes the following steps: performing heat treatment on a mixture of low-purity lithium carbonate and barium oxide; leaching the resulting product obtained through the heat treatment by adding water to form a first slurry including an insoluble by-product and a soluble component solution in which a soluble component is dissolved; converting lithium carbonate included in the soluble component to lithium hydroxide by adding a barium hydroxide solution to the first slurry, thereby forming a second slurry; filtering the second slurry to separate a lithium hydroxide solution and the insoluble by-product; and evaporating the lithium hydroxide solution separated through the filtering of the second slurry, thereby obtaining lithium hydroxide.

A third method may be the same as the second method except for performing heat treatment on a mixture of low-purity lithium carbonate, barium oxide, and barium hydroxide in the step of performing the heat treatment in the second method.

In this case, one or more reactions represented by Chemical Equations 1 and 2 below occur in the step of performing the heat treatment included in all of the first to third methods described above. Thus, the resulting product obtained through the heat treatment includes barium carbonate and one or more among lithium hydroxide and lithium oxide. The heat treatment may be performed in an inert atmosphere at a temperature in a range of 100° C. to 250° C., more specifically in the range of 150° C. to 200° C., for 2 to 4 hours. In particular, when the temperature exceeds 250° C., there may be a problem in that lithium carbonate is formed again. Additionally, in the heat treatment of the first method, lithium carbonate and barium hydroxide may be included in a molar ratio in a range of 1:0.5 to 1:1.5, more specifically in the range of 1:0.8 to 1:1.2. Furthermore, in the step of performing the heat treatment in the second method, lithium carbonate and barium oxide may be included in a molar ratio in a range of 1:0.5 to 1:1.5, more specifically in the range of 1:0.8 to 1:1.2. In the step of performing the heat treatment in the third method, lithium carbonate, barium hydroxide, and barium oxide are included such that the total amount of barium hydroxide and barium oxide is in a range of 0.5 to 1.5 moles per 1 mole of lithium carbonate. However, within the above molar ratio, one among barium hydroxide and barium oxide may be included at maximum while including the other at minimum. In this case, the molar ratio of lithium carbonate to barium hydroxide and/or barium oxide is determined through experiments, such that lithium hydroxide may be prepared most efficiently and economically within the above molar ratio range.

Li₂CO₃(s)+Ba(OH)₂(s)→2LiOH(s)+BaCO₃(s) [Chemical Equation 1]

Li₂CO₃(s)+BaO(s)→Li₂O (s)+BaCO₃(s) [Chemical Equation 2]

Next, when the step of leaching the resulting product is performed, in the first method, the first slurry in which the lithium hydroxide solution, in which solid phase lithium hydroxide (LiOH) produced in Chemical Equation 1 is dissolved by the added water, and the insoluble components, including barium carbonate (BaCO₃), are mixed may be obtained. Additionally, in the second and third methods, reactions represented by Chemical Equations 3 and 4 below occur. Thus, the second slurry in which insoluble components, including barium carbonate (BaCO₃), and the solutions of lithium hydroxide and lithium carbonate in which the soluble components, lithium oxide and lithium carbonate, are dissolved are mixed may be obtained. In this case, the step of leaching the resulting product may be performed by adding an appropriate amount of distilled water on the basis of the solubility of lithium oxide.

Li₂O(s)+H₂O→2LiOH(aq) [Chemical Equation 3]

Li₂CO₃(s)→Li₂CO₃(aq) [Chemical Equation 4]

As a result, a reaction represented by Chemical Equation 5 below may occur in the step of converting lithium carbonate in the second and third methods. In other words, all remaining lithium carbonate may be converted to lithium hydroxide because when the barium hydroxide solution is added to the second slurry, the lithium carbonate solution included in the second slurry reacts with the barium hydroxide solution.

Li₂CO₃(aq.)+Ba(OH)₂(aq.)→2LiOH(aq.)+BaCO₃(s) [Chemical Equation 5]

In the step of evaporating the lithium hydroxide solution in the first to third methods, a reaction represented by Chemical Equation 6 below occurs, thereby obtaining high-purity lithium hydroxide suitable for lithium batteries. The step of evaporating the lithium hydroxide solution may be performed with the treatment of the lithium hydroxide solution at a temperature in a range of 40° C. to 60° C. under a vacuum condition.

LiOH+xH₂O→LiOH·H₂O [Chemical Equation 6]

If necessary, the first to third methods may further include a step of performing reduction heat treatment on a mixture of a carbon raw material and the insoluble by-product obtained through the step of filtering the first or second slurry in a reducing atmosphere. In this case, a reaction represented by Chemical Equation 7 below may occur in the step of performing the reduction heat treatment. The reduction heat treatment may be performed in an inert atmosphere (nitrogen, argon, and the like) at a temperature in a range of 800° C. to 1,200° C., more specifically in the range of 850° C. to 1,100° C., for 2 to 4 hours. In particular, when the reduction heat treatment is performed at high temperatures exceeding the temperature range mentioned above, there may be a problem in that energy costs may increase rapidly, which is inefficient.

BaCO₃(s) (99.5%)+C(s)→BaO(s)+2CO(g): 2CO+O₂→2CO₂ [Chemical Equation 7]

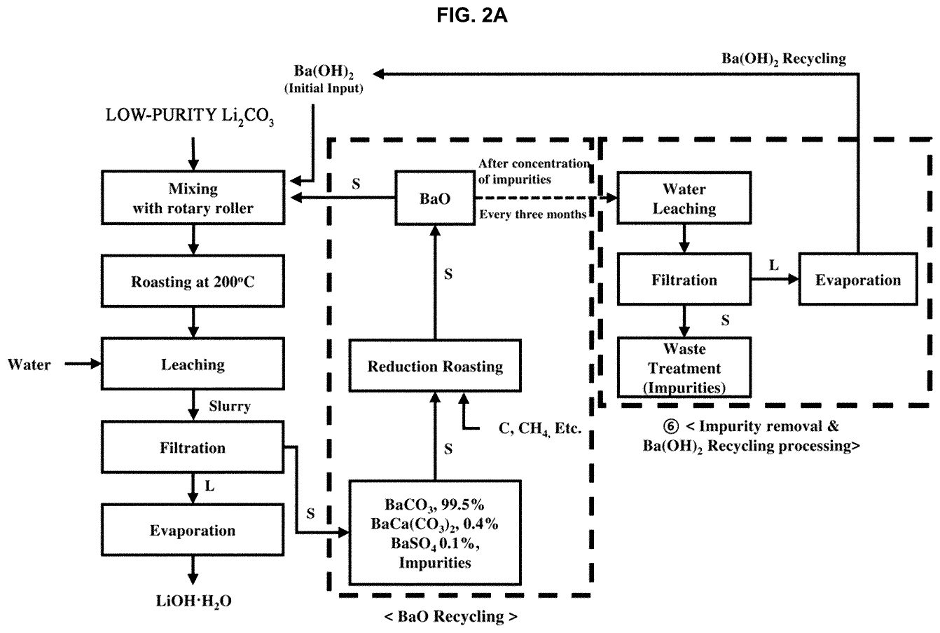

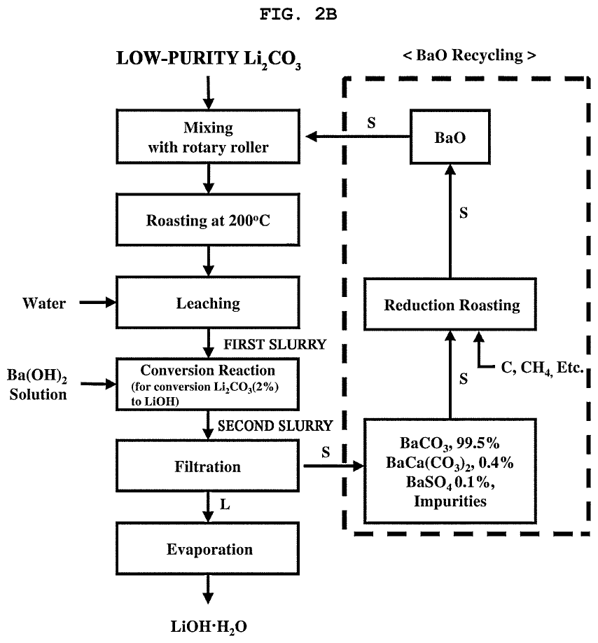

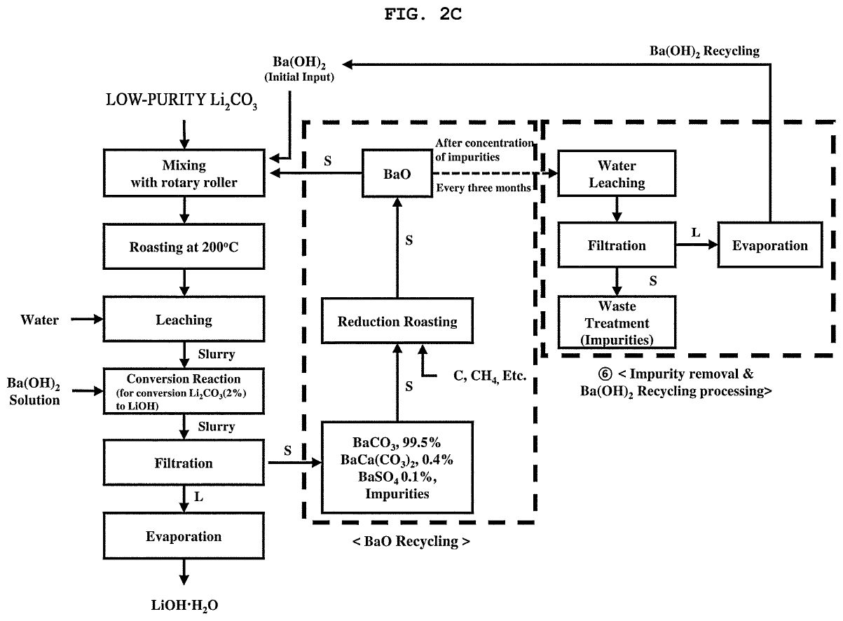

Although any known carbon materials may be used, the carbon raw material used in the step of performing the reduction heat treatment in one embodiment may include any one or more selected from the group consisting of graphite, activated carbon, carbon black, amorphous carbon, and a combination thereof. In particular, barium carbonate included in the insoluble by-product and the carbon raw material may be mixed such that a molar ratio thereof is in a range of 1:0.95 to 1:2. When the carbon raw material is added with a molar ratio of lower than 1:0.95, there is a concern in that barium carbonate fails to be sufficiently converted to barium oxide, and when the carbon raw material is added with a molar ratio exceeding 1:2, there is a concern in that process costs for barium oxide conversion increase, and resources may be unnecessarily wasted. When obtained from the reaction represented by Chemical Equation 7 through the step of performing the reduction heat treatment, BaO(s) is reusable as barium oxide required in the step of performing the heat treatment in the second and third methods. As a result, as shown in FIGS. 2B and 2C, the second and third methods of the present disclosure not only enable high-purity lithium hydroxide to be prepared but also are environmentally friendly by recycling the by-products obtained through this process, and may furthermore reduce the costs for by-product removal and raw material.

On the other hand, to obtain and reuse the barium hydroxide required in the step of performing the heat treatment in the first and third methods from the resulting product obtained through the reduction heat treatment, the following steps may be further included: leaching the resulting product obtained through the reduction heat treatment by adding water to form a third slurry including an aqueous barium hydroxide solution and impurities; filtering the third slurry to separate the aqueous barium hydroxide solution and the impurities; and evaporating the barium hydroxide solution separated through the filtering of the third slurry to obtain barium hydroxide. These steps are performed because when a reaction represented by Chemical Equation 8 below occurs in the step of leaching the resulting product, and a reaction represented by Chemical Equation 9 occurs in the step of the barium hydroxide solution, solid-phase barium hydroxide may be obtainable. In particular, when the reaction represented by Chemical Equation 8 occurs, a small amount of heavy metals that act as impurities may be removed from the Ba(OH)₂ solution in the form of oxides. Additionally, the step of evaporating the barium hydroxide solution to obtain barium hydroxide may be performed with the treatment of the barium hydroxide solution at a temperature in a range of 90° C. to 100° C. under a vacuum condition.

BaO(s)+H₂O(l)→Ba(OH)₂(aq.) [Chemical Equation 8]

Ba(OH)₂(aq.)+xH₂O→Ba(OH)₂(s) [Chemical Equation 9]

As described above, the solid-phase barium hydroxide [Ba(OH)₂(s)] obtained through the reaction represented by Chemical Equations 8 and 9 is reusable as barium hydroxide required in the step of performing the heat treatment in the first and third methods. As a result, as shown in FIGS. 2A and 2C, the first and third methods of the present disclosure not only enable high-purity lithium hydroxide to be prepared, but also recycle barium carbonate, the by-product obtained through this process, to reduce costs for by-product removal, which is environmentally friendly, and reduce the raw material costs of barium hydroxide.

### Example 1

Lithium hydroxide was prepared by performing the following steps as shown in FIG. 2A.

### 1. Heat Treatment Step

Industrial lithium carbonate (90% purity) and barium hydroxide were mixed such that a molar ratio thereof was 1:1, charged into an electric furnace, and subjected to heat treatment at a temperature of 200° C. for 2 hours in a nitrogen atmosphere at atmospheric pressure.

### 2. Leaching Step

A first slurry was obtained by washing the resulting product obtained through the heat treatment with 200 parts by weight of water per 100 parts by weight thereof.

### 3. Filtering Step

The first slurry was filtered using a vacuum filtration device to separate a lithium hydroxide solution and insoluble by-products.

### 4. Evaporating Step

The lithium hydroxide solution obtained through the filtering step was processed under a vacuum condition at a temperature of 50° C. to remove water, thereby obtaining lithium hydroxide crystals.

### 5. Reduction Heat Treatment Step

The insoluble by-products (99.5% of BaCO₃, 0.4% of BaCa(CO₃)₂, 0.1% of BaSO₄, and impurities) separated through the filtering step and carbon black as a carbon raw material were charged into an electric furnace such that a molar ratio of barium carbonate, included in the insoluble by-products, to the carbon raw material was 1:1, and then subjected to reduction heat treatment at a temperature of 1,000° C. for 3 hours in a nitrogen atmosphere.

### 6. Leaching Step to Form Third Slurry

A third slurry was prepared by washing the resulting product obtained through the reduction heat treatment step with 200 parts by weight of water per 100 parts by weight thereof.

### 7. Filtering Step

The third slurry was filtered using a vacuum filtration device to separate an aqueous barium hydroxide solution and impurities.

### 8. Evaporating Step

The barium hydroxide solution obtained through the filtering step was processed under a vacuum condition at a temperature of 50° C. to remove water, thereby obtaining barium hydroxide crystals.

### 9. Reusing Step

The barium hydroxide crystals obtained through the evaporating step were reused in the initial heat treatment step.

### Example 2

Lithium hydroxide was prepared by performing the following steps as shown in FIG. 2B.

### 1. Heat Treatment Step

Industrial lithium carbonate (90% purity) and barium oxide were mixed such that a molar ratio thereof was 1:1, charged into an electric furnace, and then subjected to heat treatment at a temperature of 200° C. for 2 hours in a nitrogen atmosphere at atmospheric pressure.

### 2. Leaching Step

A first slurry was obtained by washing the resulting product obtained through the heat treatment step with 200 parts by weight of water per 100 parts by weight thereof.

### 3. Converting Step

A second slurry was formed by adding a barium hydroxide solution in an amount corresponding to a 1:1 molar ratio to the remaining lithium concentration in the first slurry.

### 4. Filtering Step

The second slurry was filtered using a vacuum filtration device to separate a lithium hydroxide solution and insoluble by-products.

### 5. Evaporating Step

The lithium hydroxide solution obtained through the filtering step was processed under a vacuum condition at a temperature of 50° C. to remove water, thereby obtaining lithium hydroxide crystals.

### 6. Reduction Heat Treatment Step

The insoluble by-products (99.5% of BaCO₃, 0.4% of BaCa(CO₃)₂, 0.1% of BaSO₄, and impurities) separated through the filtering step and carbon black as a carbon raw material were charged into an electric furnace such that a molar ratio of barium carbonate, included in the insoluble by-products, to the carbon raw material was 1:1, and then subjected to reduction heat treatment at a temperature of 1,000° C. for 3 hours in a nitrogen atmosphere.

### 7. Reusing Step

The resulting product obtained through the reduction heat treatment was reused instead of barium oxide in the initial heat treatment step.

### Example 3

Lithium hydroxide was prepared by performing the following steps as shown in FIG. 2C.

### 1. Heat Treatment Step

Industrial lithium carbonate (90% purity), barium oxide, and barium hydroxide were mixed such that a molar ratio thereof was 1:1, charged into an electric furnace, and then subjected to heat treatment at a temperature of 200° C. for 2 hours in a nitrogen atmosphere at atmospheric pressure. In this case, the molar ratio of barium oxide to barium hydroxide is 0.1:1.

### 2. Leaching Step

A first slurry was obtained by washing the resulting product obtained through the heat treatment step with 200 parts by weight of water per 100 parts by weight thereof.

### 3. Converting Step

A second slurry was formed by adding a barium hydroxide solution in an amount corresponding to a 1:1 molar ratio to the remaining lithium concentration in the first slurry.

### 4. Filtering Step

The second slurry was filtered using a vacuum filtration device to separate a lithium hydroxide solution and insoluble by-products.

### 5. Evaporating Step

The lithium hydroxide solution obtained through the filtering step was processed under a vacuum condition at a temperature of 50° C. to remove water, thereby obtaining lithium hydroxide crystals.

### 6. Reduction Heat Treatment Step

The insoluble by-products (99.5% of BaCO₃, 0.4% of BaCa(CO₃)₂, 0.1% of BaSO₄, and impurities) separated through the filtering step and carbon black as a carbon raw material were charged into an electric furnace such that a molar ratio of barium carbonate, included in the insoluble by-products, to the carbon raw material was 1:1, and then subjected to reduction heat treatment at a temperature of 1,000° C. for 3 hours in a nitrogen atmosphere.

### 7. Reusing Step of Barium Oxide

The resulting product obtained through the reduction heat treatment was reused instead of barium oxide in the initial heat treatment step.

### 8. Leaching Step to Form Third Slurry

When the concentration of impurities in the reusing step of barium oxide reached a level that affected the end product, a third slurry was prepared by washing the resulting product obtained through the reduction heat treatment step with 200 parts by weight of water per 100 parts by weight thereof.

### 9. Filtering Step

The third slurry was filtered using a vacuum filtration device to separate an aqueous barium hydroxide solution and impurities.

### 10. Evaporating Step

The barium hydroxide solution obtained through the filtering step was processed under a vacuum condition at a temperature of 50° C. to remove water, thereby obtaining barium hydroxide crystals.

### 11. Reusing Step of Barium Oxide

The obtained barium hydroxide crystals were reused in the initial heat treatment step.

### Experimental Example 1

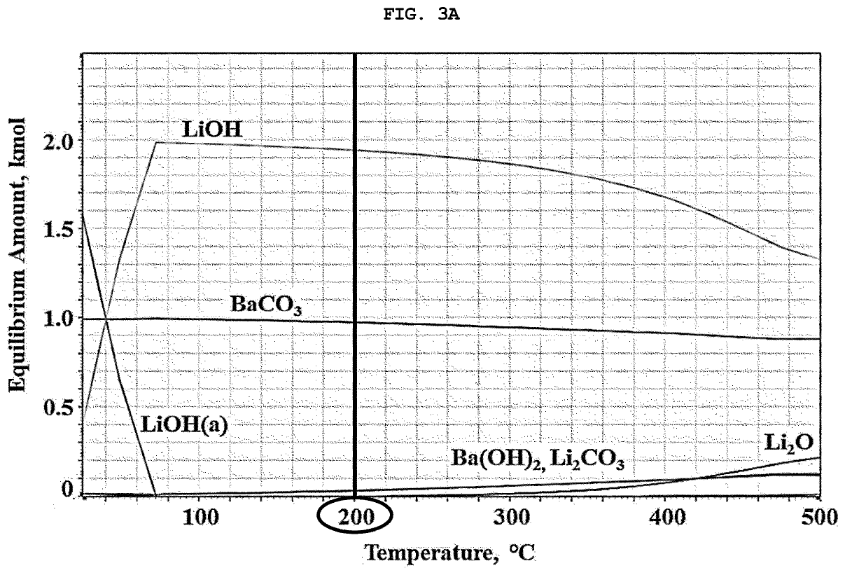

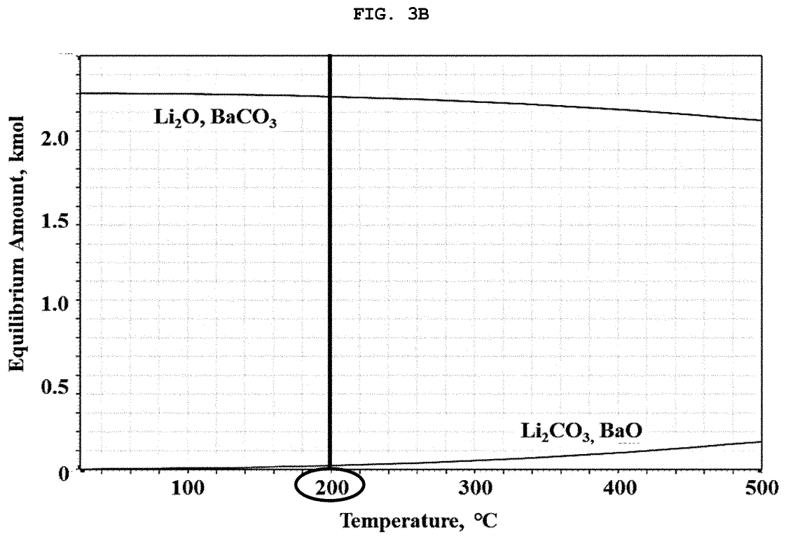

Using a process simulator based on thermodynamic simulation results, conditions for the heat treatment steps of industrial lithium carbonate and barium hydroxide in Example 1 and industrial lithium carbonate and barium oxide in Example 2 were analyzed. Considering the analyzed results, heat treatment was performed according to the conditions in Examples 1 and 2. The resulting respective data are shown in FIGS. 3A and 3B.

From FIG. 3A, it is seen that LiOH production is possible using industrial Li₂CO₃ and Ba(OH)₂ and that BaCO₃, an insoluble material, is produced as the by-product. Additionally, from FIG. 3B, it is seen that Li₂O production is possible using industrial Li₂CO₃ and BaO and that BaCO₃, the insoluble material, is produced as the by-product.

### Experimental Example 2

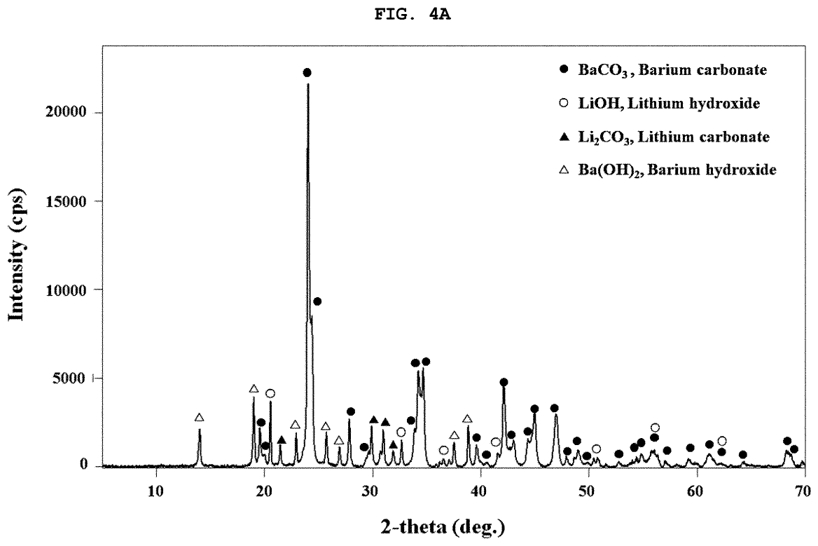

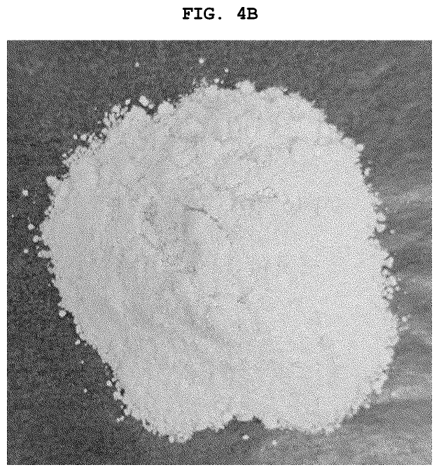

The resulting product obtained through the heat treatment step in Example 1 was subjected to XRD analysis. The resulting graph and actual image are shown in FIGS. 4A and 4B, respectively.

From FIG. 4A, as a result of the XRD analysis, it was confirmed that Li₂CO₃ and Ba(OH)₂ turned into LiOH and BaCO₃ through a phase change, and trace amounts of Li₂CO₃ and Ba(OH)₂ were present. However, the trace amounts of Li₂CO₃ and Ba(OH)₂ were confirmed to be converted to LiOH and BaCO₃ after water leaching.

### Experimental Example 3

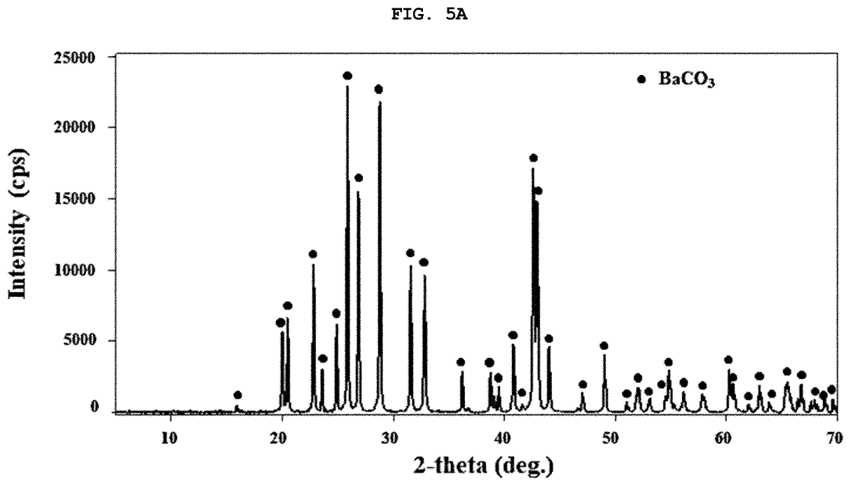

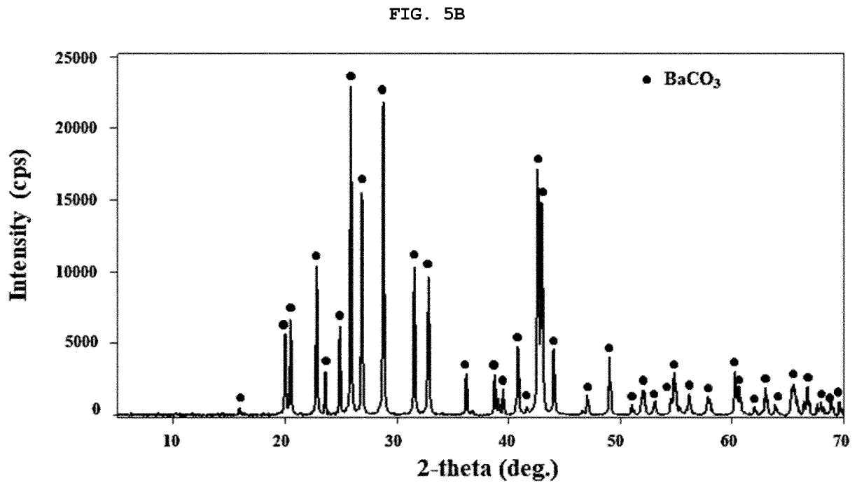

Each of the insoluble by-products obtained through the filtering step in Examples 1 and 2 were subjected to XRD analysis. The resulting respective graphs are shown in FIGS. 5A and 5B.

From FIGS. 5A and 5B, showing the results of the XRD analysis performed on the residues from the respective solid phases, that is, the insoluble by-products, it was confirmed that 99.5% or more of the solid-phase residues were BaCO₃.

### Experimental Example 4

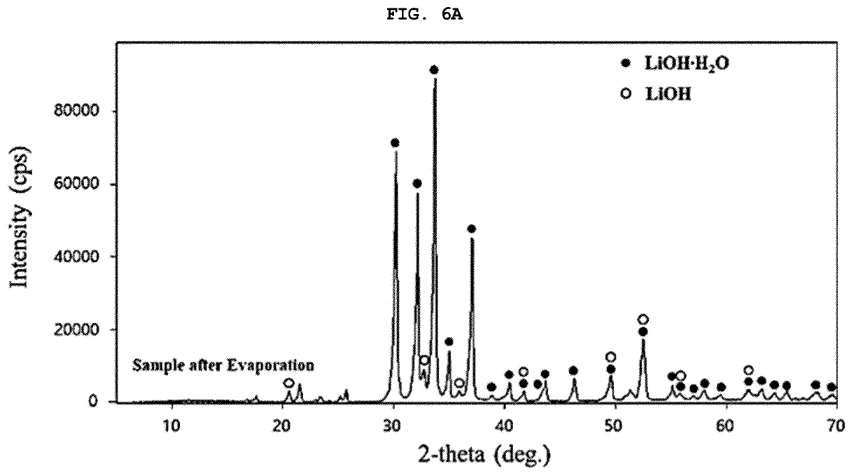

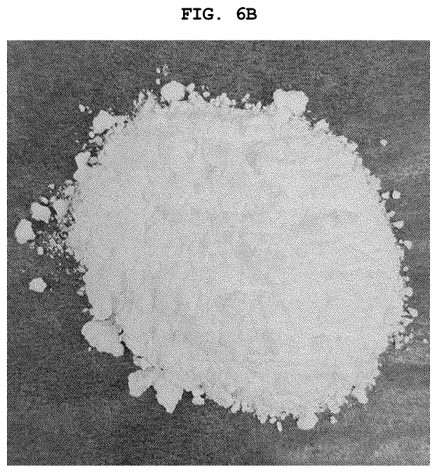

The lithium hydroxide crystals, obtained through the evaporating steps in Examples 1 to 3 to obtain lithium hydroxide, were subjected to XRD analysis. The resulting graphs are shown in FIGS. 6A and 6B.

When performing the evaporating step on the solution containing lithium hydroxide obtained through the filtering step, solid-phase products are enabled to be prepared as shown in FIG. 6B. In this case, it was confirmed from the XRD results that the products were mostly LiOH·H₂O, as shown in FIG. 6B, and a small amount of LiOH was prepared.

### Experimental Example 5

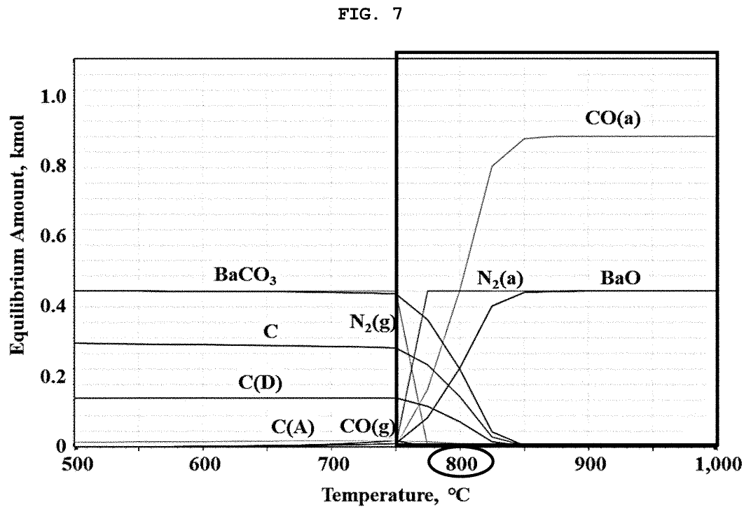

Using a process simulator based on thermodynamic simulation results, conditions for the reduction heat treatment steps performed in Examples 1 to 3 were analyzed. Reduction heat treatment was performed according to the conditions obtained from the analyzed results. The resulting data are shown in FIG. 7.

From FIG. 7, when performing the reduction heat treatment on BaCO₃, the insoluble by-product, using the carbon raw material (C), a reaction represented by Chemical Equation 7 occurs, thereby producing barium oxide (BaO). Additionally, such produced barium oxide is recyclable. As described above, when the insoluble by-product is reusable as barium oxide, the reduction of raw materials may enable economic feasibility to be significantly improved. Furthermore, from the above results, it is seen that in the case where the ratio of C in the carbon raw material to BaCO3 is 1:1, 2CO(g) may be produced, and CO(g) may be oxidized and discharged as CO₂(g).

### Experimental Example 6

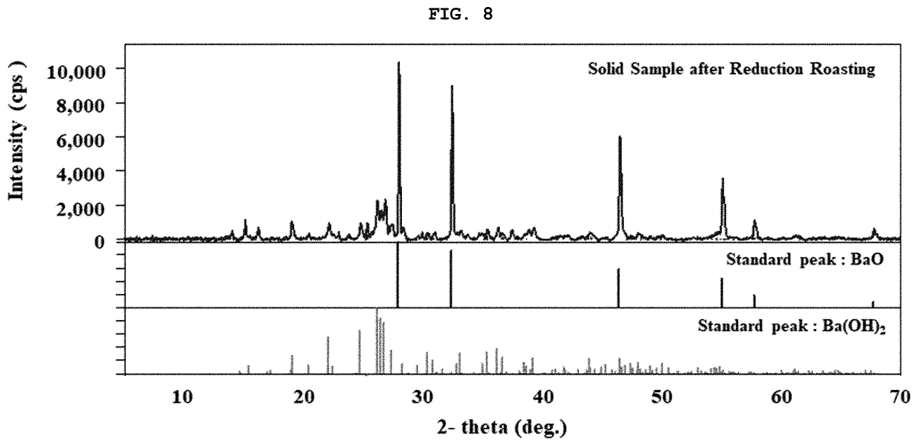

The resulting product obtained through the reduction heat treatment in Example 2 was subjected to XRD analysis. The resulting graph is shown in FIG. 8.

As shown in FIG. 8, it is confirmed that the solid-phase product is BaO.

### Experimental Example 7

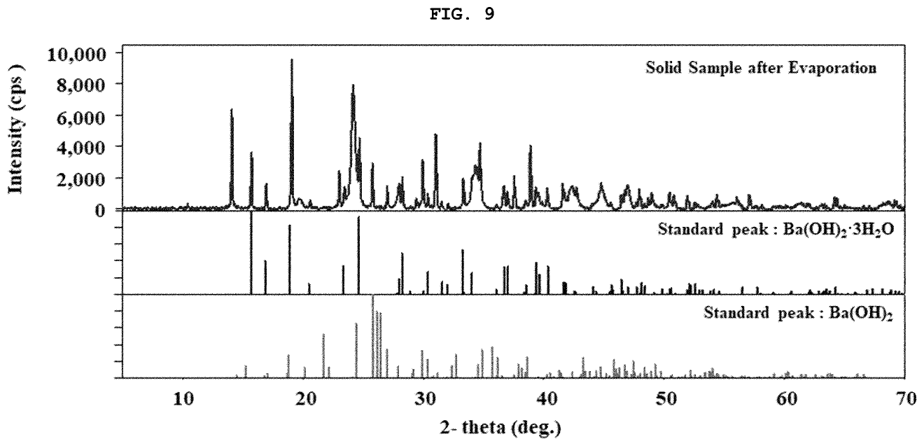

The barium hydroxide crystals, obtained through the evaporating steps in Examples 1 and 3 to obtain barium hydroxide, were subjected to XRD analysis. The resulting graph is shown in FIG. 9.

When performing the evaporating step on the solution containing barium hydroxide obtained through the filtering step to filter the third slurry, solid-phase products are enabled to be prepared. As shown in FIG. 9, it is confirmed that the solid-phase products are Ba(OH)₂·3H₂O and Ba(OH)₂.

Although the present disclosure has been illustrated and described with the preferred embodiments as discussed above, the present disclosure is not limited to the above-described embodiments, and it should be understood by those skilled in the art to which the present disclosure belongs that various changes and modifications can be made without departing from the technical spirit and scope of the present disclosure.

1: A method of preparing lithium hydroxide, the method comprising:
performing heat treatment on a mixture of low-purity lithium carbonate and barium hydroxide;
leaching the resulting product obtained through the heat treatment by adding water to form a first slurry comprising an aqueous lithium hydroxide solution and an insoluble by-product;
filtering the first slurry to separate the lithium hydroxide solution and the insoluble by-product; and
evaporating the lithium hydroxide solution separated through the filtering of the first slurry, thereby obtaining lithium hydroxide.

2: A method of preparing lithium hydroxide, the method comprising:
performing heat treatment on a mixture of low-purity lithium carbonate and barium oxide;
leaching the resulting product obtained through the heat treatment by adding water to form a first slurry comprising an insoluble by-product and a soluble component solution in which a soluble component is dissolved;
converting lithium carbonate comprised in the soluble component to lithium hydroxide by adding a barium hydroxide solution to the first slurry, thereby forming a second slurry;
filtering the second slurry to separate a lithium hydroxide solution and the insoluble by-product; and
evaporating the lithium hydroxide solution separated through the filtering of the second slurry, thereby obtaining lithium hydroxide.

3: A method of preparing lithium hydroxide, the method comprising:
performing heat treatment on a mixture of low-purity lithium carbonate, barium hydroxide, and barium oxide;
leaching the resulting product obtained through the heat treatment by adding water to form a first slurry comprising an insoluble by-product and a soluble component solution in which a soluble component is dissolved;
converting lithium carbonate comprised in the soluble component to lithium hydroxide by adding a barium hydroxide solution to the first slurry, thereby forming a second slurry;
filtering the second slurry to separate a lithium hydroxide solution and the insoluble by-product; and
evaporating the lithium hydroxide solution separated through the filtering of the second slurry, thereby obtaining lithium hydroxide.

4: The method of claim 1, wherein in the performing of the heat treatment, one or more reactions represented by Chemical Equations 1 and 2 occur.
Li₂CO₃(s)+Ba(OH)₂(s)→2LiOH(s)+BaCO₃(s) [Chemical Equation 1]
Li₂CO₃(s)+BaO(s)→Li₂O(s)+BaCO₃(s) [Chemical Equation 2]

5: The method of claim 2, wherein in the leaching of the resulting product, reactions represented by Chemical Equations 3 and 4 occur.
Li₂O(s)+H₂O→2LiOH(aq) [Chemical Equation 3]
Li₂CO₃(s)→Li₂CO₃(aq) [Chemical Equation 4]

6: The method of claim 5, wherein in the converting of lithium carbonate, a reaction represented by Chemical Equation 5 occurs.
Li₂CO₃(aq.)+Ba(OH)₂(aq.)→2LiOH(aq.)+BaCO₃(s) [Chemical Equation 5]

7: The method of claim 1, wherein in the evaporating of the lithium hydroxide solution, a reaction represented by Chemical Equation 6 occurs.
LiOH+xH₂O→LiOH·H₂O [Chemical Equation 6]

8: The method of claim 1, further comprising performing reduction heat treatment on a mixture of a carbon raw material and the insoluble by-product obtained through the filtering of the first or second slurry in a reducing atmosphere.

9: The method of claim 8, wherein in the performing of the reduction heat treatment, a reaction represented by Chemical Equation 7 occurs.
BaCO₃(s) (99.5%)+C(s)→BaO(s)+2CO(g): 2CO+O₂→2CO₂ [Chemical Equation 7]

10: The method of claim 9, wherein BaO(s) obtained from a reaction represented by Chemical Equation 7 is reused as barium oxide required in the performing of the heat treatment.

11: The method of claim 8, further comprising:
leaching the resulting product obtained through the reduction heat treatment by adding water to form a third slurry comprising an aqueous barium hydroxide solution and impurities;
filtering the third slurry to separate the barium hydroxide solution and the impurities; and
evaporating the barium hydroxide solution separated through the filtering of the third slurry to obtain barium hydroxide.

12: The method of claim 11, wherein in the leaching of the resulting product, a reaction represented by Chemical Equation 8 occurs, and
in the evaporating of the barium hydroxide solution, a reaction represented by Chemical Equation 9 occurs.
BaO(s)+H₂O(l)→Ba(OH)₂(aq.) [Chemical Equation 8]
Ba(OH)₂(aq.)+xH₂O→Ba(OH)₂(s) [Chemical Equation 9]

13: The method of claim 12, wherein BaO(s) obtained from the reaction represented by Chemical Equation 9 is reused as barium hydroxide required in the performing of the heat treatment.

14: The method of claim 1, wherein the heat treatment is performed at a temperature in a range of 150° C. to 250° C. in an inert atmosphere.

15: The method of claim 8, wherein the reduction heat treatment is performed at a temperature in a range of 850° C. to 1,100° C. in an inert atmosphere.

16: The method of claim 8, wherein the carbon raw material comprises any one or more selected from the group consisting of graphite, activated carbon, carbon black, amorphous carbon, and a combination thereof.

17: The method of claim 8, wherein barium carbonate comprised in the insoluble by-product and the carbon raw material are mixed such that a molar ratio thereof is in a range of 1:0.95 to 1:2.

18: The method of claim 1, wherein in the performing of the heat treatment, a molar ratio of lithium carbonate to barium hydroxide or barium oxide comprised is in a range of 1:0.5 to 1:1.5.

19: The method of claim 3, wherein in the performing of the heat treatment, lithium carbonate, barium hydroxide, and barium oxide are comprised such that the total amount of barium hydroxide and barium oxide is in a range of 0.5 to 1.5 moles per 1 mole of lithium carbonate.

20: The method of claim 2, wherein in the performing of the heat treatment, a molar ratio of lithium carbonate to barium hydroxide or barium oxide comprised is in a range of 1:0.5 to 1:1.5.

21: The method of claim 2, further comprising performing reduction heat treatment on a mixture of a carbon raw material and the insoluble by-product obtained through the filtering of the first or second slurry in a reducing atmosphere.

22: The method of claim 21, wherein in the performing of the reduction heat treatment, a reaction represented by Chemical Equation 7 occurs.
BaCO3(s) (99.5%)+C(s)→BaO(s)+2CO(g): 2CO+O2→2CO2 [Chemical Equation 7]

23: The method of claim 22, wherein BaO(s) obtained from a reaction represented by Chemical Equation 7 is reused as barium oxide required in the performing of the heat treatment.

24: The method of claim 21, further comprising:
leaching the resulting product obtained through the reduction heat treatment by adding water to form a third slurry comprising an aqueous barium hydroxide solution and impurities;
filtering the third slurry to separate the barium hydroxide solution and the impurities; and
evaporating the barium hydroxide solution separated through the filtering of the third slurry to obtain barium hydroxide.

25: The method of claim 24, wherein in the leaching of the resulting product, a reaction represented by Chemical Equation 8 occurs, and
in the evaporating of the barium hydroxide solution, a reaction represented by Chemical Equation 9 occurs.
BaO(s)+H₂O(l)→Ba(OH)₂(aq.) [Chemical Equation 8]
Ba(OH)₂(aq.)+xH2O→Ba(OH)₂(s) [Chemical Equation 9]

26: The method of claim 25, wherein BaO(s) obtained from the reaction represented by Chemical Equation 9 is reused as barium hydroxide required in the performing of the heat treatment.

27: The method of claim 2, wherein the heat treatment is performed at a temperature in a range of 150° C. to 250° C. in an inert atmosphere.

28: The method of claim 21, wherein the reduction heat treatment is performed at a temperature in a range of 850° C. to 1,100° C. in an inert atmosphere.

29: The method of claim 21, wherein the carbon raw material comprises any one or more selected from the group consisting of graphite, activated carbon, carbon black, amorphous carbon, and a combination thereof.
